(19) United States
(12) Patent Application Publication
(10) Pub. No.: US 2016/0120748 A1
(43) Pub. Date: May 5, 2016

(54) PACKAGING

(71) Applicant: Multi Packaging Solutions UK Limited, Nottingham (GB)

(72) Inventors: Carol Lynn Hammond, Nottingham (GB); Nigel Davis, Nottingham (GB)

(21) Appl. No.: 14/919,420

(22) Filed: Oct. 21, 2015

(30) Foreign Application Priority Data
Nov. 3, 2014 (GB) 1419554.9
Sep. 7, 2015 (GB) 1515772.0

(51) Int. Cl. A61J 1/03

(52) U.S. Cl. CPC A61J 1/035

(57) ABSTRACT

A package includes a container made from a paperboard, cardboard or other foldable sheet material, including a two telescopic parts which together define the body of the container and which are movable apart in telescopic fashion to open the same, and having at least one pair of internal flaps. One flap of said pair of flaps is on each of the parts, and the flaps are arranged to abut together edge to edge when the parts are moved apart as aforesaid, so as to stop such opening movement. At least one of the telescopic parts is manually deformable inwardly or outwardly to release said abutment and thereby permit opening of the container. A blister pack carrier is arranged within the container and attached to the inside of one of said container parts so as to project outwardly from that part when the container is opened to provide access to the blister pack.

This application is entitled to the benefit of, and incorporates by reference essential subject matter disclosed in United Kingdom Application No. 1419554.9 filed on Nov. 3, 2014 and United Kingdom Application No. 1515772.0 filed on Sep. 7, 2015.

### BACKGROUND OF THE INVENTION

1. Technical Field

The present invention relates to child resistant packaging, particularly child resistant pharmaceutical packaging.

2. Background Information

Pharmaceutical products are frequently supplied in blister packs. A blister pack comprises one or more “blisters” which hold capsules, tablets or other items and whose face is sealed by a foil or other film. The blister contents are dispensed by the user pressing down on the blister, thereby pushing the contents of the blister out through the sealing film.

Blister packs are normally supplied in an external package from which they must be removed to allow dispensing of the contents. The present invention seeks to provide a package of this type with improved child resistance and which facilitates handling of the blister pack.

### BRIEF SUMMARY OF THE INVENTION

From a first aspect the invention provides a package comprising a container made from a paperboard, cardboard or other foldable sheet material, comprising two telescopic parts which together define the body of the container and which are movable apart in telescopic fashion to open the same, and having at least one pair of internal flaps, one flap of said pair of flaps on each of said parts, which are arranged to abut together edge to edge when the parts are moved apart as aforesaid, so as to stop such opening movement, at least one of said telescopic parts being manually deformable inwardly or outwardly to release said abutment and thereby permit opening of the container, and a blister pack carrier arranged within said container and attached to the inside of one of said container parts so as to project outwardly from that part when the container is opened to provide access to the blister pack.

With such an arrangement, the intention is that a child will not deduce that it is necessary to deform one of the telescopic parts in a particular manner in order to open the container to gain access to the blister pack inside. Moreover, the blister pack will stay attached to the one part of the container after the container is opened, so that after use the blister pack cannot be misplaced and accidentally not replaced within the container as it will be automatically returned to the container when the container is closed.

In certain embodiments, pairs of internal flaps are provided on opposed sides of the container. Thus while the invention covers a container which has just a single pair of internal flaps on one side of the container, pairs of flaps may also be provided on two or more opposed sides of the container.

Preferably the inner one of said telescopic parts is manually deformable inwardly as aforesaid.

To facilitate this deformation, at least one pair of opposed side walls of the inner container part body may be formed with intermediate lines of weakness which allow those walls to be deformed inwardly to effect release of the abutment to allow the outer part to be removed.

The line of weakness may, for example, be a fold line, a crease line or a perforated line extending longitudinally of the respective side wall, for example over only a portion of the length of the side wall.

The line of weakness may be formed generally centrally of the respective side wall, although in certain embodiments it may be displaced from the central axis of the side wall.

Additional lines of weakness may also be formed in other opposed walls of the inner part to facilitate the deformation.

The blister pack carrier may be attached to either the inner or the outer part of the container. In some embodiments, however, it is attached to the outer part.

The blister pack carrier may be attached at one end to the container part, although in other embodiments it may be attached along a side edge thereof.

In one embodiment, the blister pack carrier may be attached at one end to an end wall of the container part.

The blister pack carrier may be formed as a single sheet, simply supporting a blister pack. In other arrangements, however, the carrier may be formed from two panels between which the blister pack is received.

The blister pack carrier may itself provide additional child resistance. Thus, for example, the carrier may be of a construction similar to those shown in GB-A-2451850. In such a construction, a blister pack is slidably received between two panels. One of the panels has one or more openings for movably receiving a blister or blisters of the blister pack. The other panel has one or more dispensing openings aligned with the first panel opening, the first panel and the second panel slidably receiving the blister pack there between. A blocking member is provided which is selectively moveable between a blocking position and a dispensing position. In its blocking position the blocking member prevents movement of the blister into alignment with the dispensing opening, thereby preventing dispensing of the blister's contents through the dispensing opening, but in its dispensing position it permits the blister to be moved into alignment with said dispensing opening for dispensing the blister's contents.

The blocking member may be displaceable out of engagement with an edge of the blister pack (for example as in the embodiment of FIG. 1 of GB-A-2451850) or slidable out of contact with blisters of the blister pack (for example as shown in the embodiment of FIG. 3 of GB-2451850).

In embodiments, the blocking member is arranged at an end of the blister pack carrier remote from the latter's end of attachment to the container part.

The blocking member may be formed with the blister pack carrier or a separate member mounted therein.

The blister pack carrier may be formed as a separate part and suitably attached to one of the container parts. However, in embodiments, the blister pack carrier is formed integrally with that container part.

In an embodiment, the blister pack carrier is hingedly attached to a panel of the container part. In one embodiment, the panel is an inner panel of the container part lying under the end wall of the container part.

The invention also extends to a blank for making one of the parts of a container as set forth above. In one embodiment, a blank may comprise a row of side wall forming panels hingedly connected about a plurality of parallel fold lines; a flap attached to one edge of a wall panels for forming an abutment on a wall of the erected container; an end wall forming flap hingedly attached to the opposite edge of one of the side wall forming panels; and a plurality of blister pack carrier forming panels attached to any of the aforesaid panels.

In certain embodiments, respective flaps are provided on a pair of side wall forming panels to provide abutments on opposed walls of the erected container.

For example, the blister carrier forming panels may be attached to the other panel of the said pair of side wall panels, for example through an attachment panel. In an alternative arrangement, the blister carrier forming panels are attached to an end of the row of side wall forming panels for example through an attachment panel, for example a glue panel.

The blister pack carrier panels may comprise a first panel having one or more openings, for example one or more slots, for movably receiving one or more blisters of the blister pack, and a second panel hingedly attached to the first panel and having one or more dispensing openings for alignment with the first panel opening or openings, the first panel and the second panel slidably receiving the blister pack therebetween. The first or second panel may be hingedly attached to the blister pack carrier attachment panel about a further fold line.

A blocking member forming panel may be hingedly attached to the first or second panel about a yet further fold line.

The blocking member forming panel may be attached to the first or second panel at an end opposite the end of the first or second panel to the end at which the first or second panel is attached to the side wall forming panels.

The blocking member forming panel may be attached to the first or second panel by means of one or more sacrificial attachment panels. These attachment panels are removed prior to use to allow the blocking panel to move between its blocking and dispensing positions.

The present method and advantages associated therewith will become more readily apparent in view of the detailed description provided below, including the accompanying drawings.

### BRIEF DESCRIPTION OF THE DRAWINGS

An embodiment of the invention will now be described by way of example and with reference to the accompanying drawings.

FIG. 1 shows a perspective view of a package in accordance with the invention.

FIG. 2 shows the outer part of the container of the package of FIG. 1.

FIG. 3 shows the inner part of the container of the package of FIG. 1.

FIG. 4 shows a blank for making the outer part of the container of the package of FIG. 1.

FIG. 5 shows the first of a sequence of views of the erection of the blank of FIG. 4.

FIG. 6 shows the second of a sequence of views of the erection of the blank of FIG. 4.

FIG. 7 shows the third of a sequence of views of the erection of the blank of FIG. 4.

FIG. 8 shows the fourth of a sequence of views of the erection of the blank of FIG. 4.

FIG. 9 shows the fifth of a sequence of views of the erection of the blank of FIG. 4.

FIG. 10 shows a blank for making the inner part of the container of the package of FIG. 1.

FIG. 11 shows a modified inner container part.

### DETAILED DESCRIPTION OF THE INVENTION

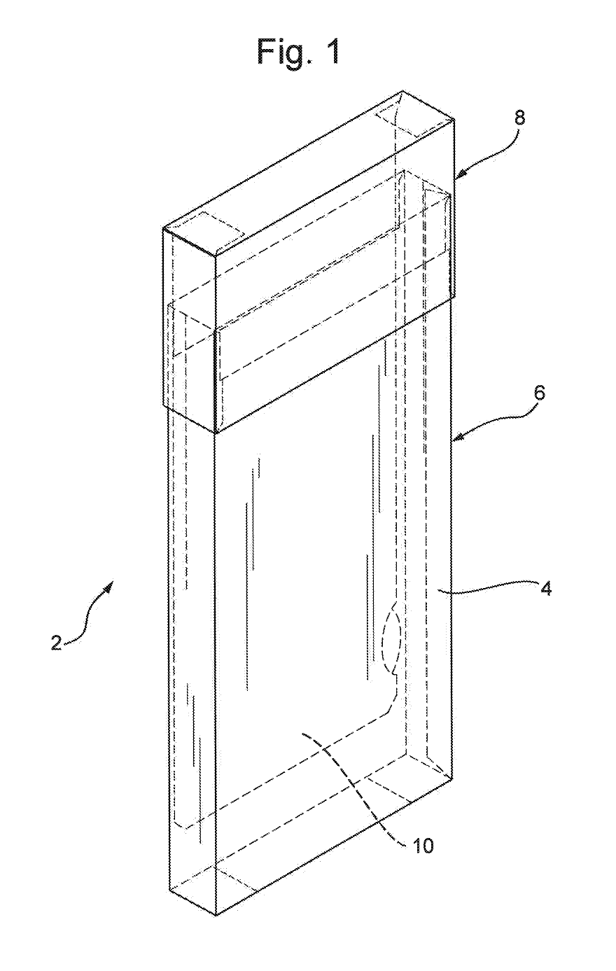

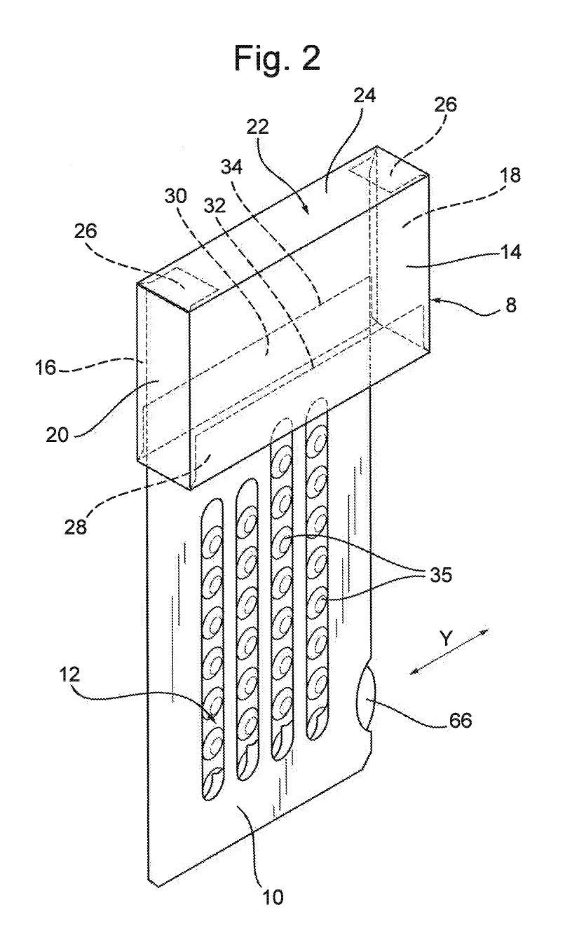

Referring to FIGS. 1 to 3, a package 2 in accordance with an embodiment of the invention comprises a container 4 having two body parts 6, 8, in this embodiment an inner part 6 and a removable outer part 8. A blister pack carrier 10, which carries a blister pack 12 (FIG. 2) is attached to the outer part 8 as will be described further below.

With reference to FIG. 2, the outer part 8 is formed with a first pair of opposed side walls 14, 16 joined by a second pair of side walls 18, 20. The outer part 8 further comprises a top or end wall 22. The end wall comprises an outer panel 24 and an inner panel 26 folded under the top panel 24. The blister pack carrier 10 is attached to the inner panel 26 of the top wall, as will be described further below.

Two flaps 28, 30 are attached to the lower edges of the first pair of opposed side walls 14, 16 and folded inwardly and glued to the respective side walls to form respective abutment edges 32, 34.

The blister pack carrier 10 is formed with a blocking member 66 which is slidable in a direction Y to allow the blister pack 12 to be moved to a position in which the contents of individual blisters 35 may be dispensed, as will be discussed further below. The blister pack carrier 10 extends from the outer part 8 a distance which is sufficient to allow a user access to all the blisters 34 of the blister pack 12.

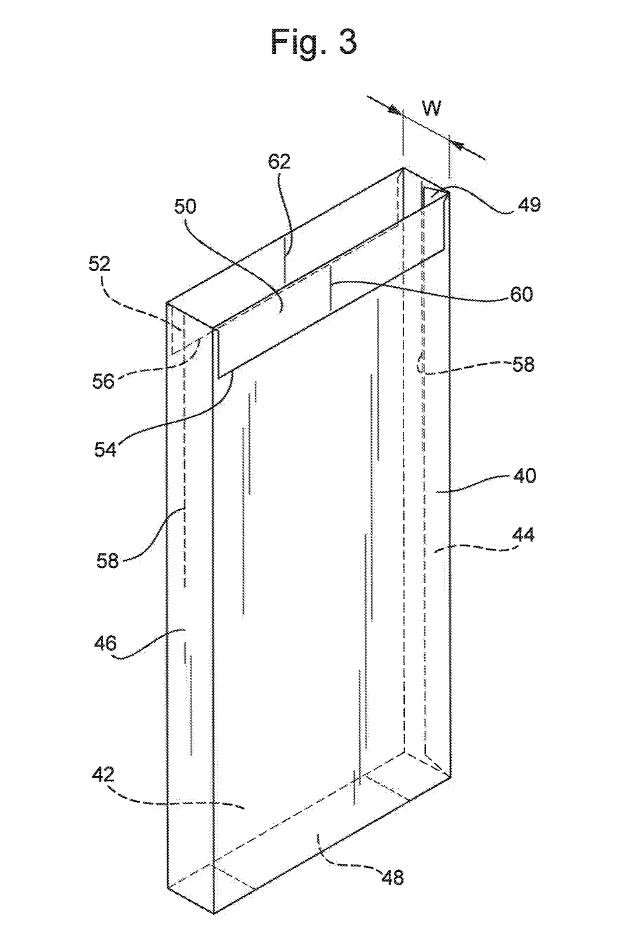

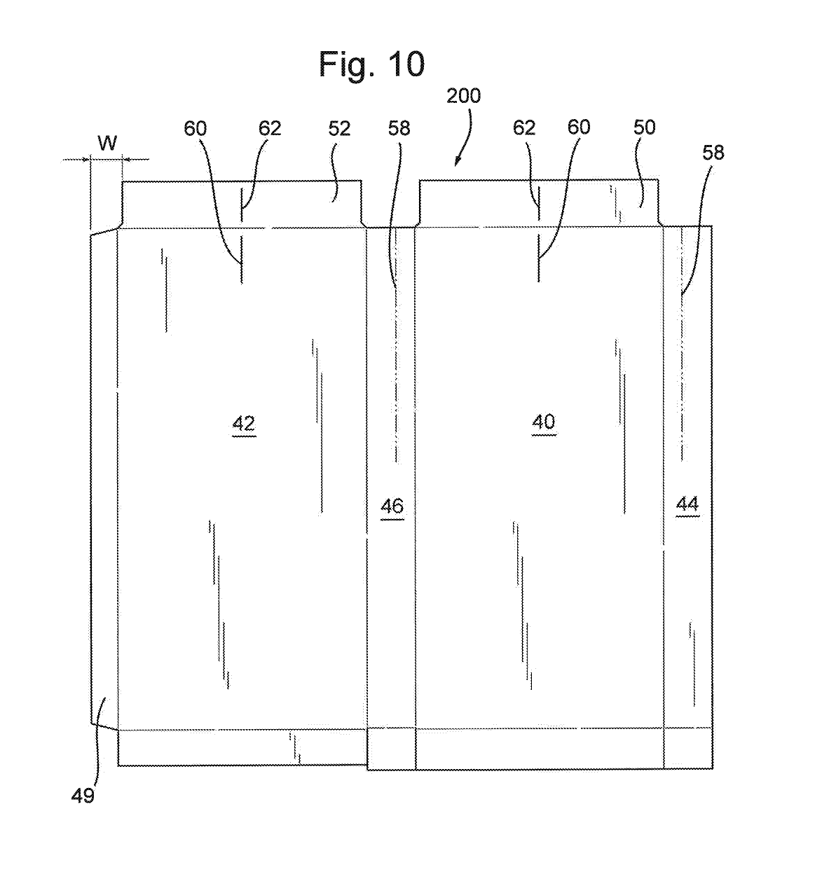

With reference to FIG. 3, and FIG. 10, which shows a blank 200 for forming the inner part 6 of the container. The inner part 6 comprises a first pair of opposed side walls 40, 42 a second pair of opposed side walls 44, 46 and an end or base wall 48. A glue flap 49 attaches side walls 42, 44 together.

Flaps 50, 52 are attached to the upper end of the first pair of side walls 40, 42 and folded outwardly and glued to the outer surfaces of the respective side walls 40, 42 to form respective abutment edges 54, 56.

Each side wall of the second pair of side walls 44, 46 comprises a line of weakness 58 formed as a crease line, a fold line or as perforations. The lines of weakness 58 are arranged offset from the centerline of each side wall 44, 46 so as to accommodate the width w of the glue flap 49, which is greater than half the width of the side wall panel 44. The glue flap 49 does not project beyond the line of weakness 58, so as to facilitate opening of the container, and the asymmetrical arrangement of the fold line 58 enables a wider glue flap to be accommodated to increase the bond area between the glue flap 49 and the side wall 44. Of course, depending on the particular size of the container, and in particular the depth of the container, this may not be necessary, and the lines of weakness 58 may be formed centrally of the side walls 44, 46, or even on the other side of the centerline of the side walls 44, 46.

The upper regions of the walls 40, 42 of the first pair of opposed side walls 40, 42, and the flaps 52 attached thereto are each formed with a respective crease line or other line of weakness 60, 62 formed generally centrally thereof. This will facilitate opening of the package 2.

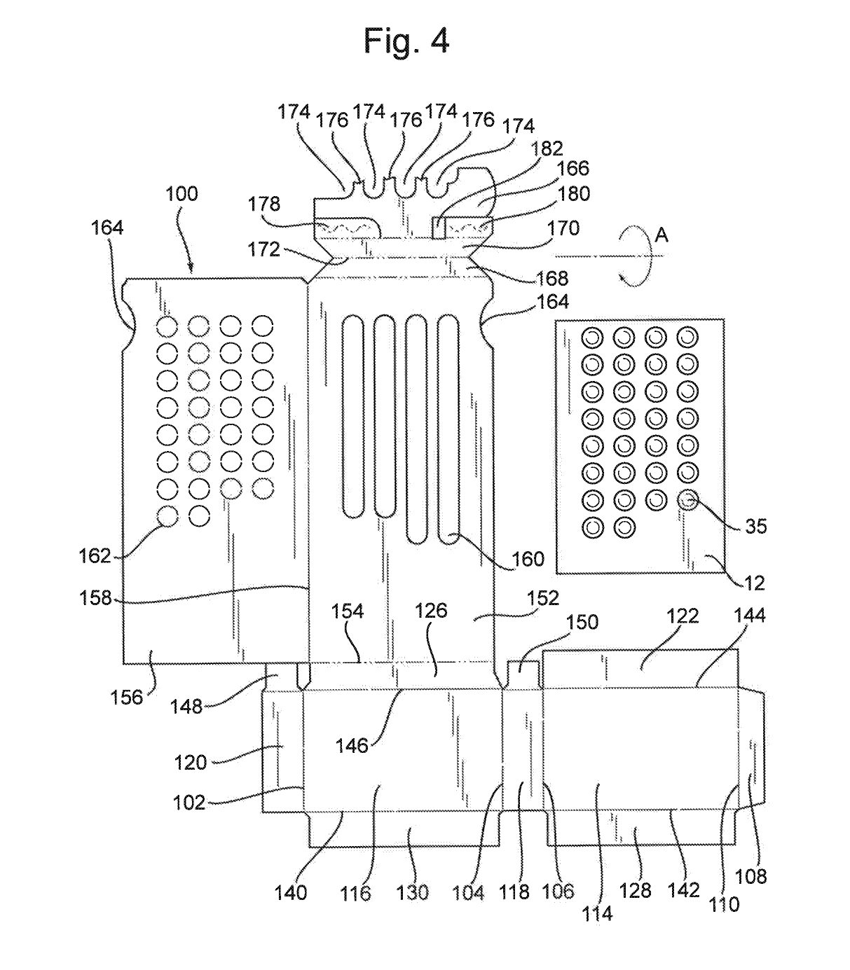

Returning to the outer part 8, more detail will now be given of the blister carrier 10 and its method of attachment to the outer part 8. This can best be understood with reference to FIGS. 4 to 9.

FIG. 4 shows a blank 100 for making the outer part 8 of the container 4. The blank 100 is of paperboard, cardboard or other foldable sheet material. The blank 100 comprises a plurality of panels for forming the walls of the outer part 8 and a plurality of panels for forming the blister pack carrier 10.

The outer part 8 comprises a first pair of side wall forming panels 114, 116 and a second pair of side wall forming panels 118, 120 hingedly connected about a plurality of parallel fold lines 102, 104, 106. A glue tab 108 is hingedly attached to side wall forming panel 114 about a further parallel fold line 110.

Flaps 128, 130 are hingedly attached to one edge of the first pair of side wall forming panels 114, 116 about generally co-linear fold lines 140, 142. An outer end wall forming flap 122 is hingedly connected to the opposite edge of side wall forming panel 114 about a fold line 144. An inner end wall forming panel 126 is hingedly connected to the opposite edge of side wall forming panel 116 about a further fold line 146. The fold lines 144, 146 are orthogonal to the fold lines 102, 104, 106, which join the side wall forming panels 114, 116, 118, 120. Two glue tabs 148, 150 are hingedly attached to the edges of the respective second side wall forming panels 118, 120.

The panels described above will, when assembled, form the outer part 8. Attached to the inner end wall forming panel 126 are a plurality of panels which will form the blister carrier 10.

A first blister carrier panel 152 is hingedly attached to the inner end wall forming panel 126 about a hinge line 154. A second blister carrier panel 156 is hingedly attached to the first blister carrier panel 152 about a further fold line 158 which is orthogonal to the hinge line 154. The first blister carrier panel 152 has a series of slots 160 for slidably receiving rows of blisters 34 of a blister pack 12 (also shown in FIG. 4). The second blister carrier panel 156 has a series of openings 162, each covered by a removable, e.g. perforated, cover, arranged so as to align with the blisters 34 of the blister pack 12 when the blister pack 12 is in a dispensing position. Respective notches 164 are provided in opposed edges of the first and second blister carrier panels 152, 156.

A generally T-shaped blocking member panel 166 is connected to the opposite end of the first blister carrier panel 152 by means of first and second attachment panels 168, 170 and a fold line 172. The blocking member 166 is similar in its principle of construction and operation to that shown in FIG. 3 of GB-A-2451850, having recesses 174 for receiving blisters 34 of the blister pack 12 in use, the recesses separated by projections 176. Also attached to the second attachment panel 168 (but not to the blocking member panel 166) are glue tabs 178, 180. An opening 182 is formed between one end of the glue tab 178 and the blocking member panel 166.

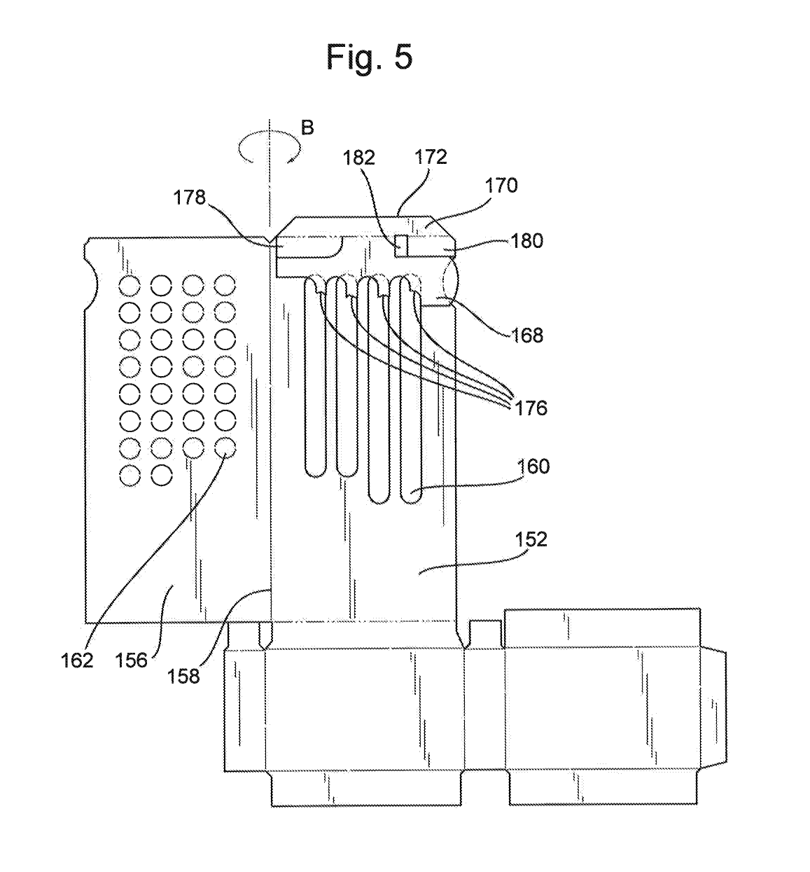

Assembly of this embodiment will now be described. As a first step, as shown in FIG. 5, the blocking member panel 166, together with glue tabs 178, 180 and the second attachment panel 170 are folded inwardly about fold line 172 (as indicated by arrow A) so as to overlie the face of the first blister carrier panel 154. The glue tabs 178, 180 are glued to the first blister carrier panel 152.

As a second step, blister pack 12 is then located on the first blister carrier panel 152 with its blisters 34 received in the slots 160, with the projections 176 of the blocking member panel 166 engaging the so that they are held out of alignment with the openings 162 in the second blister carrier panel 156. The first and second steps may be performed in reverse order.

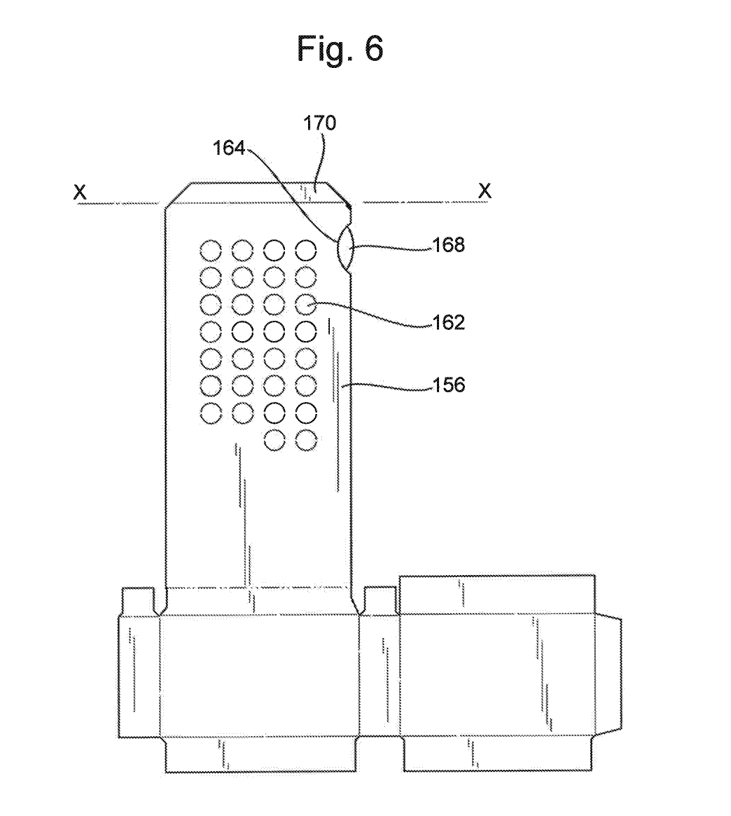

Then as shown in FIG. 5, the second blister carrier panel 156 is folded about hinge line 158 (as indicated by arrow B) and glued to first blister carrier panel 152 around its two longer sides and its bottom edge and also glued at its top edge to the glue tabs 180. It is not glued to the blocking member panel 166. The blister pack 12 is therefore sandwiched between the first and second blister carrier panels 152, 156. The blank after gluing is illustrated in FIG. 6, from which it will also be seen that an edge portion 184 of the blocking member panel 166 is accessible through the notches 164.

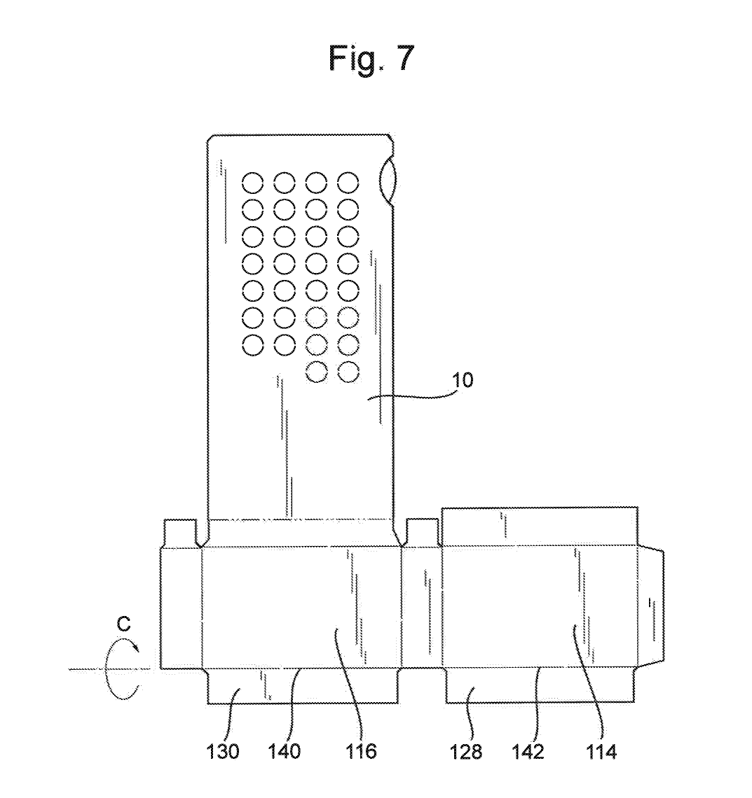

As a next step, the first and second attachment panels 168, 170 are separated from the blank 100 by cutting across line X-X shown in FIG. 6. This releases the blocking member panel 166 from the blank 100 so that the blocking member 66 so formed is free to move laterally relative thereto to the extent defined by the opening 182. The blank 100 after removal of the attachment panels 178, 180 is illustrated in FIG. 7.

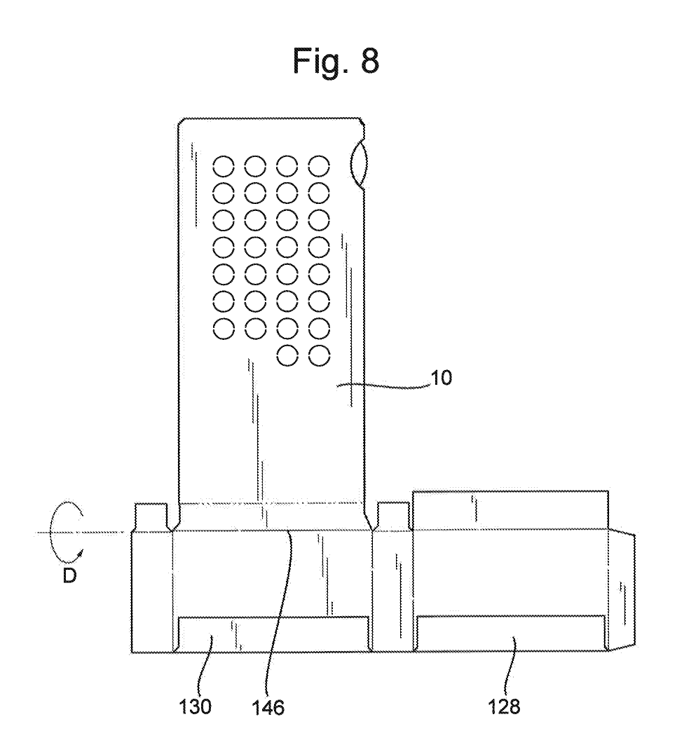

Then the flaps 128, 130 are folded inwardly about hinge lines 140, 142, as indicated by the arrow C in FIG. 6 and glued to the inner faces of the side wall forming panels 114, 116. The blank after this stage is illustrated in FIG. 8.

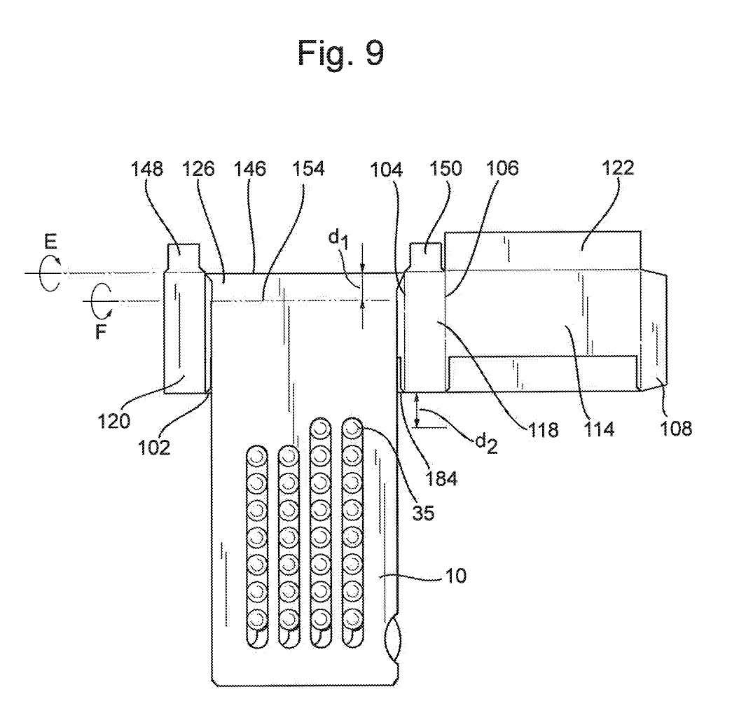

Then, the blister carrier 10 is folded inwardly about hinge line 146 as illustrated by arrow D in FIG. 8. In this position, the blister carrier 10 lies over side wall forming panel 116, as shown in FIG. 9. It will be seen from FIG. 9 that the blister carrier 10 extends downwardly beyond the side wall forming panel 116. In fact, the upper end of each slot 160 is spaced a distance d₂ from the lower edge 184 of the side wall forming panel 116 which is greater than the depth d₁ of the inner end wall forming panel 126.

The outer 8 part is finally erected by folding the side wall forming panels 114, 118, 120 inwardly about the respective hinge lines 102, 104, 106 and gluing the glue tab 108 to the inner surface of the side wall forming panel 120. The inner top wall forming panel 126 is then folded up through 90° around hinge line 146, as illustrated by arrow E in FIG. 9, and the blister carrier folded down through 90° about arrow F, the glue tabs 148, 150 folded inwardly and glued to the inner top wall forming panel 126 and the outer end wall forming panel 122 then folded inwardly and glued to the tabs 148 and the inner end wall forming panel 126 to form the end wall 22 of the outer part 8.

The blister pack 10 therefore extends outwardly from the open end of the outer part 8. As the depth d₂ is greater than the depth d₁ as discussed above, the blisters 34 of the blister pack 12 will all lie below the open end of the outer part 8 and thus be easily accessible to a user. Also, as the blocking member 32 is arranged at the opposite end from the attachment to the outer part 8, it too will be easily accessible to the user.

Turning briefly to FIG. 10, this illustrates a blank 200 for producing the inner part 6 of the container 4. This blank is conventional apart from the lines of weakness 58 formed in the side wall panels 44, 46, the flaps 52 formed at the upper ends of the side wall panels 40, 42 and the crease lines 60, 62 formed in the side wall panels 40, 42 and flaps 50, 52 respectively. The arrangement and purpose of these features has been described above. The erection of the blank 200 is conventional and therefore need not be described in detail.

In use, it will be appreciated that when the outer part 8 is positioned fully over the inner part 6, the flaps 50, 52 on the inner part 6 and the flaps 28, 30 will move past one another. The flaps' abutment edges 32, 34, 54, 56 will prevent the outer part 8 being removed from the inner part 6. Removal of the outer part 8 is achieved by pressing inwardly the side walls 44, 46 of the inner part, and/or on the side walls 40, 42 thereof. The lines of weakness 58 in the side walls 46, 48 and the crease lines 60, 62 in the side walls 40, 42 will facilitate the deformation of the side walls 44, 46 which draws the side walls 40, 42 slightly closer together, this movement being sufficient for the abutment between the pairs of flaps 32, 34, 52, 54 to be temporarily released, so that the outer part 8 can be lifted off the inner part 6.

The contents of the blister pack 12 can then be accessed. To do so, a user grips the visible edge of the blocking member 32 and pulls the blocking element outwardly along direction Y as shown in FIG. 2 into its dispensing position. This moves the projections 176 out of alignment with the blisters 34, allowing the blister pack 12 to be slid along the slots 60 in the first blister carrier panel 152 to a position in which the blisters 34 align with the covered openings 62 in the second blister carrier panel 156. The contents of the blister 34 may then be dispensed by pushing the contents out through the openings 62, breaking the covers in doing so.

After dispensing, the blocking member 32 may be slid back to its blocking position and the outer part 8 replaced on the inner part 6.

Thus two levels of child resistance are provided. Firstly, the child must disengage the outer part 8 and inner part 6 to release the outer part 8. The child must then operate the blocking mechanism to release the blister contents.

It will be appreciated that this is a description of just one embodiment of the invention and that variations thereto are possible within the scope of the invention. For example, the blister carrier may be of a different construction, having a blocking member which is depressed out of contact with an edge of the blister pack to allow movement of the blister pack to a dispensing position, as exemplified in FIG. 1 of GB-A-2451850.

Also, while the blister carrier 10 has been shown to be connected to an end wall of the outer part 8, it could be attached to another panel. For example, it could be attached to the free edge of the glue tab 108 so that it is attached in effect to a side wall of the outer part 8 rather than the end wall of the outer part 8. Also, the blister carrier 10 may of course be attached to the inner part 6, rather than the outer part 8.

In a further variation, the blocking member may be formed separately from the remainder of the blister pack carrier and suitably located therein during assembly of the blister pack carrier.

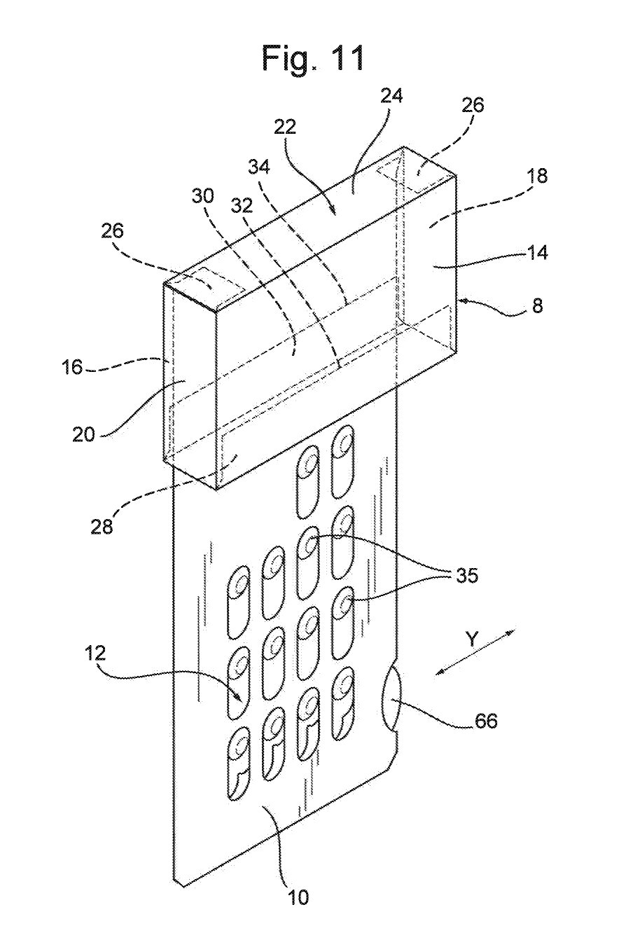

It should also be noted that although continuous slots 160 have been illustrated in the embodiment above, it will be appreciated that shorter slots may be provided, for example associated with individual blisters 35. One such arrangement is illustrated in FIG. 11. Here, slots 260 accommodate individual blisters 35 rather than a row of blisters. It has been found that this may enhance child resistance, making it more difficult for a child to try to extract a blister pack via the slots in use.

Although this invention has been shown and described with respect to the detailed embodiments thereof, it will be understood by those skilled in the art that various changes in form and detail may be made without departing from the spirit and scope of the invention.

What is claimed:

1. A package comprising a container made from a paperboard, cardboard or other foldable sheet material, comprising a two telescopic parts which together define the body of the container and which are movable apart in telescopic fashion to open the same, and having at least one pair of internal flaps, one flap of said pair of flaps on each of said parts, which are arranged to abut together edge to edge when the parts are moved apart as aforesaid, so as to stop such opening movement, at least one of said telescopic parts being manually deformable inwardly or outwardly to release said abutment and thereby permit opening of the container, and a blister pack carrier arranged within said container and attached to the inside of one of said container parts so as to project outwardly from that part when the container is opened to provide access to the blister pack.

2. The package as claimed in claim 1 wherein the inner one of said telescopic parts is manually deformable inwardly as aforesaid.

3. The package as claimed in claim 1 wherein pairs of internal flaps are provided on opposed sides of said container.

4. The package as claimed in claim 1, wherein opposed side walls of the inner container part body are formed with intermediate lines of weakness which allow those walls to be deformed inwardly to effect release of the abutment to allow the outer part to be removed.

5. The package as claimed in claim 4, wherein the line of weakness is a fold line, a crease line or a perforated line extending longitudinally of the container body.

6. The package as claimed in claim 5, wherein the line of weakness is displaced from the central axis of the side wall.

7. The package as claimed in claim 4, comprising additional lines of weakness formed in other opposed walls of the container part.

8. The package as claimed in claim 1, wherein the blister pack is attached to the outer container part.

9. The package as claimed claim 1, wherein the blister pack carrier is attached at one end to the container part.

10. The package as claimed in claim 9, wherein the blister pack carrier is attached at one end to an end wall of the container part.

11. The package as claimed in claim 1, wherein the blister pack carrier is formed from two panels between which the blister pack is received.

12. The package as claimed in claim 11, wherein one of the panels has one or more openings for movably receiving a blister of the blister pack, the other panel has one or more dispensing openings aligned with the first panel opening, wherein the blister pack is slidably received between two panels, and further comprising a blocking member arranged between the panels and selectively moveable between a blocking position and a dispensing position.

13. The package as claimed in claim 12, wherein the blocking member is displaceable out of engagement with an edge of the blister pack.

14. The package as claimed in claim 12, wherein the blocking member is slidable out of contact with blisters of the blister pack.

15. The package as claimed in claim 12, wherein the blocking member is arranged at an end of the blister pack carrier remote from the end of attachment of the blister pack carrier to the container part.

16. The package as claimed in claim 1, wherein the blister pack carrier is formed integrally with the container part to which it is attached.

17. The package as claimed in claim 16, wherein the blister pack carrier is hingedly attached to a panel of the container part.

18. The package as claimed in claim 17, wherein the panel is an inner panel of an end wall of the container part.

19. A blank for erection into a container part, the blank comprising:
a row of side wall forming panels hingedly connected about a plurality of parallel fold lines;
at least one flap attached to one edge of at least one wall panels for forming an abutment on a wall of the erected container,
an end wall forming flap hingedly attached to the opposite edge of one of the said side wall forming panels; and
a plurality of blister pack carrier forming panels attached to any of the aforesaid panels.

20. The blank as claimed in claim 19, wherein a pair of flaps are attached to one edge of a pair of wall panels for forming abutments on opposed walls of the erected container, wherein the plurality of blister pack carrier forming panels are attached to the other of said pair of the said side wall forming panels and comprising a blister pack carrier attachment panel hingedly attached to an edge of the said other of the said pair of side wall forming panels, for connecting said blister pack carrier forming panels to the said other of the said pair of side wall forming panels.
